(19) United States
(12) Patent Application Publication
(10) Pub. No.: US 2025/0129226 A1
(43) Pub. Date: Apr. 24, 2025

(54) FOAMED POLYLACTIC ACID SHEET, AND METHOD FOR PRODUCING FOAMED POLYLACTIC ACID SHEET

(71) Applicant: Satoshi Ogawa, Nara (JP)

(72) Inventor: Satoshi Ogawa, Nara (JP)

(73) Assignee: Ricoh Company, Ltd., Tokyo (JP)

(21) Appl. No.: 18/689,098

(22) PCT Filed: Sep. 2, 2022
(86) PCT No.: PCT/IB2022/058244

§ 371 Date: Mar. 5, 2024

(30) Foreign Application Priority Data
Sep. 16, 2021 (JP) 2021151348

(51) Int. Cl. C08J 9/00

(52) U.S. Cl. CPC C08J 9/0066; C08J 2201/026; C08J 2201/03; C08J 2367/04

(57) ABSTRACT

A foamed polylactic acid sheet has a polylactic acid resin. The foamed polylactic acid sheet has oligomers and monomers having molecular weights of 3,000 or less in a total amount of 1,000 ppm or less.

### TECHNICAL FIELD

The present disclosure relates to a foamed polylactic acid sheet, and a method for producing a foamed polylactic acid sheet.

### BACKGROUND ART

In recent years, environmental awareness has increased, and activities of Sustainable Development Goals (SDGs) have been actively progressing. Under this situation, expectations for biodegradable resins and plant-derived plastics have been increasing, and particularly, developments of plastic products made of polylactic acid resins that are plant-derived and compostable (can be composted) have been promoted.

On the other hand, since plastic products made of polylactic acid resins are more hygroscopic than general resins and prone to hydrolysis during processing, formed products of polylactic acid resins include oligomers and monomers and therefore have problems of growth of bacteria and the like and poor bacteriostatic properties.

For widely using polylactic acids, there is a proposition of a foamed polylactic acid sheet in which an amount of the polylactic acid is decreased by foaming the polylactic acid (e.g. see Patent Literature 1). To facilitate processing of the polylactic acid into various shapes such as bag, container, and tray forms depending on applications, an operation that the polylactic acid is once processed into a sheet shape is widely performed.

### CITATION LIST

### Patent Literature

[PTL 1]
Japanese Patent No. 4713274

### SUMMARY OF INVENTION

### Technical Problem

An object of the present invention is to provide a biodegradable foamed polylactic acid sheet that is hardly contaminated and excellent in environmental hygiene.

### Solution to Problem

The foamed polylactic acid sheet according to embodiments of the present invention contain a polylactic acid resin, and oligomers and monomers having molecular weights of 3,000 or less in a total amount of 1,000 ppm or less.

### Advantageous Effects of Invention

Embodiments of the present invention provide a biodegradable foamed polylactic acid sheet that is hardly contaminated and excellent in environmental hygiene.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a phase diagram illustrating a state of a substance with respect to temperature and pressure.

FIG. 2 is a phase diagram for defining a phase range of a compressible fluid.

FIG. 3 is a schematic diagram illustrating a continuous kneading apparatus used for producing a foam according to embodiments of the present invention.

FIG. 4 is a schematic diagram illustrating a continuous foaming apparatus used for producing the foam according to embodiments of the present invention.

### DESCRIPTION OF EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

### (Foamed Polylactic Acid Sheet)

The foamed polylactic acid sheet according to embodiments of the present invention contains a polylactic acid resin (hereinafter, also referred to as “polylactic acid”), preferably contains a crosslinking agent, and inorganic particles, as well as, as necessary, other components.

In the foamed polylactic acid sheet according to embodiments of the present invention, a total amount of oligomers and monomers having molecular weights of 3,000 or less is 1,000 ppm or less. When the total amount of the oligomers and monomers having molecular weights of 3,000 or less is 1,000 ppm or less, the foamed polylactic acid sheet is prevented from being contaminated by bacteria to acquire excellent bacteriostatic property and food freshness keeping property.

During production of the foamed polylactic acid sheet according to embodiments of the present invention, the polylactic acid resin is prevented from hydrolyzing by kneading the polylactic acid resin at a temperature of the polylactic acid resin being 150° C. or lower, resulting in a foamed polylactic acid sheet including oligomers and monomers having molecular weights of 3,000 or less in a total amount of 1,000 ppm or less.

A related art has had a problem that, since a polylactic acid resin is processed at a high temperature of 190° C. or higher, the polylactic acid resin hydrolyzes to contain oligomers and monomers having low molecular weights, and therefore bacterial contamination occurs and bacteriostatic property deteriorates.

As a result of the inventors' intensive study, it has been found that, during production of the foamed polylactic acid sheet, the polylactic acid resin is prevented from hydrolyzing by kneading the polylactic acid resin at a temperature of the polylactic acid resin being 150° C. or lower, resulting in a foamed polylactic acid sheet including oligomers and monomers having molecular weights of 3,000 or less in a total amount of 1,000 ppm or less.

A content of the oligomers and monomers having molecular weights of 3,000 or less according to embodiments of the present invention can be measured e.g. using a high performance liquid chromatography (manufactured by Shimadzu Corporation) or the like. Specifically, the measurement can be performed in accordance with the following conditions and procedures.

### [Condition]

Column: Inertsil ODS-3 (5 μm, 4.6 mm×250 mm)
Eluate: 0.1% H₃PO₄ aq
Flow rate: 1.0 mL/min
Temperature: 40° C.
Detector: UV 210 nm

### <Polylactic Acid Resin>

Examples of the polylactic acid resin may include copolymers of a D-lactic acid and an L-lactic acid, a homopolymer of either a D-lactic acid (D body) or an L-lactic acid (L body), one or a plurality of lactide ring-opened polymers selected from a group consisting of a D-lactide (D body), an L-lactide (L body), and a DL-lactide. Each of these polylactic acid resins may be used alone or in combination of two or more types.

When using a copolymer of a D-lactic acid and an L-lactic acid as the polylactic acid resin, a ratio between the D-lactic acid and the L-lactic acid is not particularly limited and can be selected as appropriate depending on an intended purpose. As for the copolymer of the D-lactic acid and the L-lactic acid, there is a tendency that as the lesser optical isomer decreases, a crystallinity, a melting point, and a glass transition point of the copolymer become higher. Also, there is a tendency that as the lesser optical isomer increases, the crystallinity become lower, and the copolymer becomes amorphous. Since the crystallinity is associated with heat resistance of the foamed polylactic acid sheet and a forming temperature, the copolymer only needs to be used depending on an application, and the crystallinity is not particularly limited. The aforementioned crystallinity expresses a crystallinity degree or a crystallization speed, and the high crystallinity means either “high crystallinity degree” or “high crystallization speed”.

The polylactic acid may be synthesized as appropriate, or a commercially available polylactic acid may be used.

From the viewpoint of biodegradability and recyclability (easy recycling), a proportion of the polylactic acid resin is preferably 95% by mass or more, more preferably 98% by mass or more, particularly preferably 99% by mass based on the foamed polylactic acid sheet. A polylactic acid resin proportion of less than 95% may cause a defect that other components remain even after the polylactic acid resin is biodegraded.

### <Method for Measuring Proportion of Polylactic Acid>

The proportion of the polylactic acid is not particularly limited and can be selected as appropriate depending on an intended purpose. For example, the proportion can be calculated from a ratio among materials (“material ratio”) to be compounded. If the material ratio is unknown, for example, the materials are compared with a known polylactic acid as a reference sample by the following gas chromatography mass spectrometry (GCMS) analysis, so that components of the materials can be specified. As necessary, the material ratio can also be calculated using an area ratio of spectra according to nuclear magnetic resonance (NMR) measurement and other analytical methods in combination.

### —Measurement by GCMS Analysis—

GCMS: QP2010 manufactured by Shimadzu Corporation; auxiliary equipment: Py3030D manufactured by Frontier Laboratories Ltd.
Separation column: Ultra ALLOY UA5-30M-0.25F manufactured by Frontier Laboratories Ltd.
Sample heating temperature: 300° C.
Column oven temperature: 50° C. (kept for 1 minute)->temperature rising rate: 15° C./min->320° C. (for 6 minutes)
Ionization method: Electron Ionization (E.I.) method
Detected mass range: 25 to 700 (m/z)

### <Crosslinking Agent>

When the polylactic acid resin includes a crosslinking agent, terminals of the polylactic acid resin are crosslinked with each other and terminal groups of the polylactic acid resin are blocked, so that the polylactic acid resin hardly adsorbs water. Thereby, hydrolysis of the polylactic acid resin, and generation of monomers or oligomers having molecular weights of 3,000 or less can be suppressed. In addition, since the molecular weight of the resin considerably increases by the addition of the crosslinking agent, a viscosity of the resin increases, resulting in a uniform and fine foam state.

The crosslinking agent is preferably a (meth)acrylic ester compound having two or more (meth)acrylic groups in the molecule or having one or more (meth)acrylic groups and one or more glycidyl or vinyl group because of high reactivity with polylactic acid resins and little resin coloration.

Examples of the crosslinking agent may include glycidyl methacrylate, glycidyl acrylate, glycerol dimethacrylate, trimethylolpropane trimethacrylate, trimethylolpropane triacrylate, allyloxy polyethylene glycol monoacrylate, aryloxy polyethylene glycol monomethacrylate, polyethylene glycol dimethacrylate, polyethylene glycol diacrylate, polypropylene glycol dimethacrylate, polypropylene glycol diacrylate, polytetramethylene glycol dimethacrylate, and alkylene copolymers in which alkylene glycol moieties of these (meth)acrylates have different lengths, butanediol methacrylate, and butanediol acrylate.

A proportion of the crosslinking agent is not particularly limited and can be selected as appropriate depending on an intended purpose, and is preferably 0.5% by mass or more and 2.5% by mass or less based on the foamed polylactic acid sheet.

If the proportion is 0.5% by mass or more, the foamed polylactic acid sheet can be prevented from being punctured, and if the proportion is 2.5% by mass or less, the foamed polylactic acid sheet is excellent in surface property and moldability.

In the foamed polylactic acid sheet of the present disclosure, preferably, a difference between an endothermic amount and an exothermic amount as determined by a heat-flux differential scanning calorimetry at a heating rate of 5° C./min is 1 J/g or more and 15 J/g or less. The difference between an endothermic amount and an exothermic amount indicates crystallinity. When this value is smaller than 1 J/g, the crystallinity is so small that, even when the sheet is molded into a mold shape, the sheet tries to return to the originally shape, i.e., the sheet shape, with residual heat, resulting in shrinkage without maintaining the original shape. When this value is greater than 15 J/g, the crystallinity is so large and the viscosity is so low that the resin is prevented from stretching, resulting in generation of holes, or that the resin is prevented from stretching in an aperture direction to prevent drawing the height of the mold.

### <Inorganic Particles>

The inorganic particles are blended to control sizes and an amount of bubbles of the foam, or the like.

The inorganic particles may also serve as a foam core material. The inorganic particles that serve as the foam core material are also referred to as a filler in some cases.

The inorganic particles are not particularly limited and can be selected as appropriate depending on an intended purpose. Examples of the inorganic particles may include talc, kaolin, calcium carbonate, titanium oxide, layered silicate, zinc carbonate, wollastonite, silica, alumina, magnesium oxide, calcium silicate, sodium aluminate, calcium aluminate, sodium alumino silicate, magnesium silicate, glass balloon, carbon black, zinc oxide, antimony trioxide, zeolite, hydrotalcite, metal fiber, metal whisker, ceramic whisker, potassium titanate, boron nitride, graphite, glass fiber, and carbon fiber.

Above all, silica is preferable because of high affinity with a compressible fluid as described later.

The silica contains silicon dioxide represented by SiO₂ as a main component. According to processes for producing silica particles, silica particles can be broadly classified into two types: dry-processed silica and wet-processed silica. In the present disclosure, silica particles produced by both processes can be used.

The silica is not particularly limited and can be selected as appropriate depending on an intended purpose. It is preferable that the surface of the silica is treated with a reactive compound such as a silane coupling agent, a titanate coupling agent, and an organosiloxane. Above all, the silane coupling agent is preferable because the silane coupling agent can be suitable used for surface treatment of silica particles.

The silane coupling agent is not particularly limited and can be selected as appropriate depending on an intended purpose. Examples of the silane coupling agent may include hexamethyldisilazane, vinyltrimethoxysilane, γ-glycidoxypropyltrimethoxysilane, γ-methacryloxypropyltrimethoxysilane, γ-aminopropyltrimethoxysilane, and γ-mercaptopropyltrimethoxysilane.

A number average particle diameter of the inorganic particles is not particularly limited, and can be selected as appropriate depending on an intended purpose. The number average particle diameter is preferably 7 nm or larger and 120 nm or smaller. If the number average particle diameter is 7 nm or larger, the inorganic particles are excellent in dispersibility, an interface between the inorganic particles and the polylactic acid is increased, and sheet properties such as an impact strength of the resultant foam are improved. If the number average particle diameter is 120 nm or smaller, a uniform and sufficiently large diameter can be obtained.

The number average particle diameter of the inorganic particles can be expressed as Brunauer Emmett Teller (BET) specific surface area, conveniently assuming that the foam core material has a true spherical shape. In this case, the BET specific surface area is preferably 20 m²/g or larger and 5,000 m²/g or smaller.

The number average particle diameter of the inorganic particles can be calculated by observing the inorganic particles (filler) in the foam by transmission electron microscope (TEM) at a magnification of 50,000 times. The number of the particles used for the calculation is 100.

A proportion of the inorganic particles is not particularly limited as long as physical properties of the foamed polylactic acid sheet is not impaired, and can be selected as appropriate depending on an intended purpose. The proportion is preferably 0.3% by mass or more and 5.0% by mass or less based on the foamed polylactic acid sheet. If the proportion of the inorganic particles is 0.3% by mass or more, silica can effectively work as a foam core material to form a uniform and sufficiently large foam diameter. If the proportion of the inorganic particles is 5.0% by mass or less, the silica does not aggregate and is uniformly dispersed to form a uniform foam, so that physical properties of the sheet, such as impact strength of the foam can be improved.

The proportion of the inorganic particles can be calculated from the preparation amount in producing the foam, but can also be analyzed by an inorganic elemental analysis (EA) method (O, N, H). For example, the proportion of the inorganic particles can be quantified by a process in which the foam is put into a graphite crucible together with a flux and melted and decomposed by resistance heating in an impulse furnace in a helium stream, and oxygen is detected as carbon dioxide and hydrogen is detected as moisture by an infrared detector, and nitrogen is detected as it is by a thermal conductivity detector.

### <Other Components>

The aforementioned other components are not particularly limited and can be selected as appropriate depending on an intended purpose. Examples of other components may include a thermal stabilizer, an antioxidant, and a plasticizer. Each of these polylactic acid resins may be used alone or in combination of two or more types.

A proportion of the other components is not particularly limited and can be selected as appropriate depending on an intended purpose. In terms of recyclability, the proportion is preferably 2% by mass or less, preferably 1% by mass or less based on the foamed polylactic acid sheet.

The average bubble diameter of the foam in the foamed polylactic acid sheet according to embodiments of the present invention is preferably 0.01 μm or larger and 15 μm or smaller, more preferably 0.1 μm or larger and 8 μm or smaller. If the average bubble diameter is 0.01 μm or larger, the foam is not too small and the foam is excellent in flexibility. If the average bubble diameter is 15 μm or smaller, the foam is not too large and the foam is excellent in strength.

A method for measuring the average bubble diameter of the foam is not particularly limited, and can be selected as appropriate depending on an intended purpose. For example, the average bubble diameter can be measured by cross-sectioning the foamed polylactic acid sheet using an ion milling device and observing the cross-section using a scanning electron microscope (SEM). Specifically, in the obtained cross-sectional SEM image (magnification: 3,000×), gray components corresponding to the bubbles (voids) and resin components (white) are binarized using a software Image-Pro Premier (manufactured by Media Cybernetics, Inc.), an average particle diameter (Feret diameter) is determined in a range of 35 μm×20 μm, and an average bubble diameter of the gray components (bubbles) having a Feret diameter of 0.5 μm or larger is calculated.

A bulk density of the foam is not particularly limited and can be appropriately selected depending on an intended purpose. The bulk density is preferably 0.02 g/cm³ or higher and 0.9 g/cm³ or lower, more preferably 0.02 g/cm³ or higher and 0.7 g/cm³ or lower, particularly preferably 0.02 g/cm³ or higher and 0.5 g/cm³ or lower. If the bulk density is 0.02 g/cm³ or higher, the foam can maintain sufficient strength. If the bulk density is 0.9 g/cm³ or lower, the foam is excellent in flexibility and has flexible and rigid properties.

The bulk density of the foam can be measured e.g. in accordance with JIS K 7365.

An average thickness of the foam polylactic acid sheet according to embodiments of the present invention is not particularly limited and can be selected as appropriate depending on an intended purpose. The average thickness is preferably 0.001 mm or larger and 4 mm or smaller, more preferably 0.001 mm or larger and 1 mm or smaller. If the average thickness is 4 mm or smaller, moldability is improved.

Since the foamed polylactic acid sheet according to embodiments of the present invention is in a finely and uniformly foamed state, the thickness of the sheet can be decreased.

A ratio (long side/thickness) of a length of a long side (μm) that is longer among a length in an extrusion direction (MD direction) and a length in a width direction (TD direction) of the foamed polylactic acid sheet, to an average thickness (μm) is preferably 250 or higher, more preferably 2,500 or higher. If the ratio (longer side/thickness) is 250 or higher, the sheet can be easily processed.

The foamed polylactic acid sheet may be used as a manufactured material, or letters may be directly printed on the sheet, or the sheet may be processed using a mold to obtain a product. The process in which the sheet is processed using a mold to obtain a product is not particularly limited and can be selected as appropriate depending on an intended purpose. For example, a conventionally-known method for a thermoplastic resin can be used, such as vacuum molding, air pressure molding, vacuum/compressed-air molding, and press molding.

The foamed polylactic acid sheet can have at least any of a laminated layer, a coated layer, and a surface-deposited layer, on at least either a right face or a reverse face of the foamed polylactic acid sheet.

Examples of the shape of the multilayer body obtained by the aforementioned processing on the foamed polylactic acid sheet may include a sheet shape and a bottle shape. In the present disclosure, a sheet-shaped multilayer body may be molded into a multilayered molded article.

A method for preparing the sheet-shaped multilayer body is not particularly limited and can be selected as appropriate depending on an intended purpose. Examples of the method may include: (1) a method in which a foamed polylactic acid sheet (A) is previously prepared and a resin (B) extruded by a general melt-extruder is layered on this sheet (extrusion laminating method); and (2) a method in which two extruders are prepared, one of which extrudes a polylactic acid resin (C) to prepare a sheet, and at the same time, the other one extrudes the resin (B) (coextrusion method).

### (Method for Producing Foamed Polylactic Acid Sheet)

The method for producing the foamed polylactic acid sheet according to embodiments of the present invention includes a kneading process, a foaming process, and, as necessary, other processes.

The kneading process and the foaming process may be simultaneously or separately performed.

### <Kneading Process>

In the kneading process, the polylactic acid resin is supplied to an extruder and kneaded at a temperature of the polylactic acid resin being 150° C. or lower to obtain a polylactic acid resin composition. Kneading of the polylactic acid resin at a temperature of the polylactic acid resin being 150° C. or lower makes it possible to obtain a foamed polylactic acid sheet including oligomers and monomers having molecular weights of 3,000 or less in a total amount of 1,000 ppm or less.

In the kneading process, a foaming agent may be added in addition to the polylactic acid resin and the inorganic particles in order to promote the foaming more efficiently. The kneaded products of the polylactic acid resin and the inorganic particles are referred to as a polylactic acid resin composition or a masterbatch in some cases.

### <<Foaming Agent>>

The foaming agent is not particularly limited and can be selected as appropriate depending on an intended purpose. In terms of the ease of obtaining a foamed polylactic acid sheet based on the polylactic acid resin having a high expansion ratio, preferable examples of the foaming agent may include: a hydrocarbon e.g. a lower alkane such as propane, n-butane, isobutane, n-pentane, isopentane, and hexane; an ether such as dimethyl ether; a halogenated hydrocarbon such as methyl chloride and ethyl chloride; and a physical foaming agent e.g. a compressible gas such as carbon dioxide and nitrogen. Above all, the compressible gas such as carbon dioxide and nitrogen is preferable in terms of no odor, safe handling, and low environmental load.

When kneading the inorganic particles and the polylactic acid resin, it is preferable to use a compressible fluid. In general, it is known that the resin is plasticized by the compressible fluid to decrease a melt viscosity of the resin (see “Latest Application Technologies of Supercritical Fluid”, NTS Inc.). Although there appears to be a contradiction between the decrease in the melt viscosity and the improvement of kneadability, a pressure is applied using no compressible fluid in kneading general inorganic particles (filler) in some cases, this process is aimed to decrease a free volume of the resin to increase an interaction between resins (increase in viscosity), resulting in an opposite effect on plasticization of the resin (see K. Yang, R. Ozisik R, “Polymer”, 2006, volume 47, p. 2849).

It is known that the compressible liquid has a property of plasticizing (softening) resins, and when rising the temperature of the compressible liquid, the resin becomes like a liquid. In this state, dispersion of the inorganic particles in the resin results in a state that the inorganic particles are dispersed in the liquid, and the inorganic particles aggregate in the liquid. Thus, it has been impossible to obtain a highly dispersed resin composition. That means, since the viscosity of the resin is unsuitable for the kneading in the presence of the compressible fluid, it has been considered that it is difficult to use a compressible liquid for kneading a resin and inorganic particles.

Thus, the inventors intensively studied utilization of the compressible fluid for kneading the polylactic acid resin and the inorganic particles, and, as a result, it was found that, if the kneading was performed at a temperature lower than a melting point of the polylactic acid resin in the presence of the compressible fluid, the viscosity of the polylactic acid resin was suitable for the kneading, and the inorganic particles could be kneaded. In particular, polylactic acid resins whose melt viscosity rapidly decreases at a melting point or higher have only been kneaded in a state of a low melt viscosity so far, but in the method for producing the foamed polylactic acid sheet according to embodiments of the present invention, the inorganic particles can be kneaded in a state of high viscosity, and the compressible fluid can be directly used as the foaming agent.

### <<Compressible Fluid>>

Examples of the compressible fluid may include carbon monoxide, carbon dioxide, dinitrogen monoxide, nitrogen, methane, ethane, propane, 2,3-dimethylbutane, ethylene, and dimethyl ether. Above all, carbon dioxide is preferable because carbon dioxide can easily create a supercritical state owing to a critical pressure of about 7.4 MPa and a critical temperature of about 31° C. and can be easily handled owing to incombustibility.

Each of these compressible fluids may be used alone or in combination of two or more types.

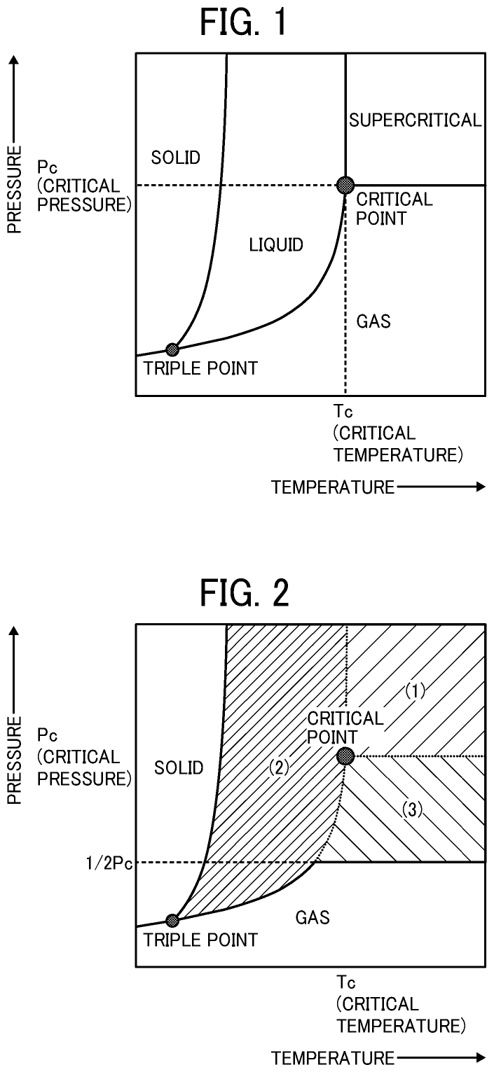

Herein, the compressible fluid used in the production of the polylactic acid resin composition will be explained with reference to FIG. 1 and FIG. 2.

FIG. 1 is a phase diagram illustrating a state of a substance with respect to temperature and pressure.

FIG. 2 is a phase diagram for defining a phase range of a compressible fluid.

In this embodiment, the “compressible fluid” refers to a state of a substance existing in any of the regions (1), (2), or (3) illustrated in FIG. 2 in the phase diagram of FIG. 1.

It is known that a substance in these regions demonstrates a very high density and a behavior different from that at normal temperature and pressure. A substance existing in the region (1) is a supercritical fluid. The supercritical fluid refers to a fluid that exists as a non-condensable high-density fluid in a temperature/pressure region above the limit (critical point) where a gas and a liquid can coexist and that does not condense even when compressed. A substance existing in the region (2) is in a liquid state, which is a liquefied gas obtained by compressing a substance in a gaseous state at normal temperature (25° C.) and normal pressure (1 atm). A substance existing in the region (3) is in a gaseous state, which is a high-pressure gas whose pressure is ½ (½Pc) or higher of the critical pressure (Pc).

Since the solubility of the compressible fluid varies depending on a combination of the resin and compressible fluid, a temperature, and a pressure, an amount of the supplied compressible fluid should be adjusted as appropriate. For example, for a combination of polylactic acid and carbon dioxide, the amount of the supplied compressible fluid is preferably 2% by mass or more and 30% by mass or less. If the amount of the supplied carbon dioxide is 2% by mass or more, it is possible to prevent an undesired phenomenon of a limited plasticization effect. If the amount of the supplied carbon dioxide is 30% by mass or less, it is possible to prevent an undesired phenomenon that carbon dioxide and polylactic acid are phase-separated and a foam having a uniform thickness cannot be obtained.

### <<Kneading Apparatus>>

A kneading apparatus used for producing the foamed polylactic acid sheet may employ either a continuous process or a batch process. The process can be selected as appropriate depending on an efficiency of the apparatus, properties and quality of products, or the like. As the kneading apparatus, it is possible to use single-screw extruders, twin-screw extruders, kneaders, non-screw cage-type stirring tanks, BIVOLAK manufactured by Sumitomo Heavy Industries, Ltd., N-SCR manufactured by Mitsubishi Heavy Industries, Ltd., glasses-like blades and lattice blades manufactured by Hitachi, Ltd., and tube-type polymerization tanks equipped with Kenix-type or Sulzer-type SMLX static mixer, or the like. In terms of color tone, self-cleaning polymerization devices such as finishers, N-SCR, and twin-screw extruders can be used. Above all, finishers and N-SCR are preferable for production efficiency, resin color tone, stability, and heat resistance.

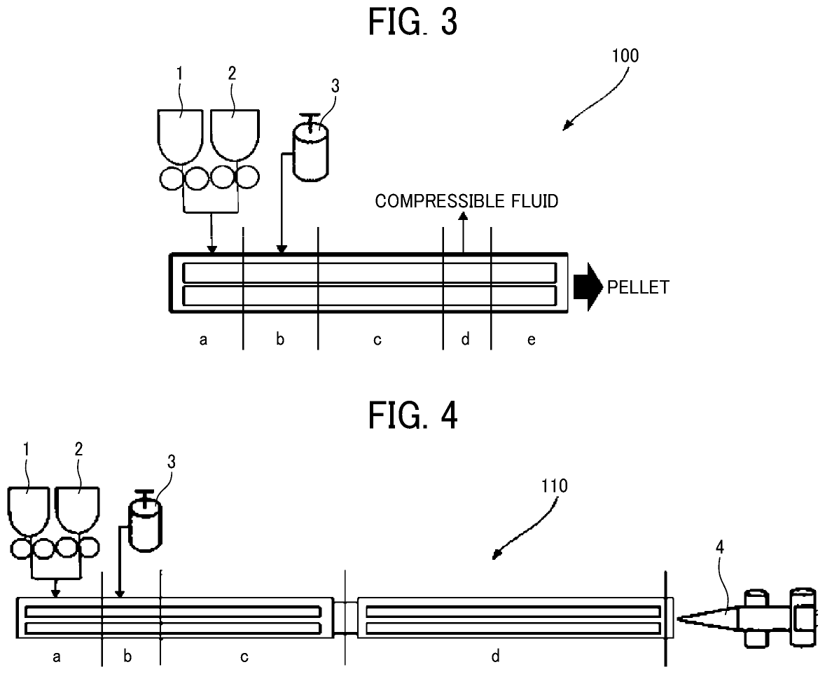

As illustrated in FIG. 3, a continuous kneading apparatus 100 includes a raw material mixing/melting area a including a twin-screw extruder (manufactured by The Japan Steel Works, Ltd., having a screw diameter of 42 mm and L/D=48, including a resin pellet supplying tank 1 and a filler supplying tank 2), a compressible fluid supply area b including a compressible fluid supplying tank 3, a kneading area c, a forming area d, a molding area e, and a circular die attached to the end thereof. A compressible fluid (liquid material) is supplied using a metering pump. Solid raw materials such as resin pellets and calcium carbonate are supplied using a quantitative feeder.

### <<Raw Material Mixing/Melting Area>>

In the raw material mixing/melting area a, a resin pellet and a filler as inorganic particles (the same applies to the following) are mixed, and the temperature is raised. The heating temperature is set to be equal to or higher than the melting temperature of the resin so that the resin can be uniformly mixed with the compressible fluid in the subsequent compressible fluid supply area.

### <<Compressible Fluid Supply Area>>

In the compressible fluid supply area b, the resin pellet is melted by warming, and the compressible fluid is supplied while the filler is in a wet state, so that the melted resin is plasticized.

### <<Kneading Area>>

The temperature of the kneading area c is set so that the viscosity becomes suitable for kneading the filler. The set temperature is not particularly limited because the set temperature varies depending on the specifications of the reactor, as well as type, structure, molecular weight, etc., of the resin. A commercially-available polylactic acid having a weight average molecular weight (Mw) of about 200,000 is generally kneaded at a temperature 10° C. to 20° C. higher than the melting point of the polylactic acid. On the other hand, in the present disclosure, characteristically the resin is kneaded at a temperature lower than the melting point of the polylactic acid, and can be kneaded with a relatively high viscosity at a temperature lower than the melting point. Specifically, the temperature is −20° C. to −80° C., more preferably −30° C. to −60° C. For simplicity, the temperature only needs to be set with reference to a current value of a stirring power of the apparatus, or the like. It can be said that these set values are in a range that can be normally reached only in the present disclosure.

### <Foaming Process>

In the foaming process, the compressible fluid is removed from the polylactic acid resin composition to foam the polylactic acid resin composition.

The compressible fluid can be removed by releasing the pressure.

The temperature during the foaming process is preferably equal to or higher than the melting point of the polylactic acid resin.

For example, specifically the foaming process can be performed as follows.

A tandem type extruder is used, in which a second extruder (L/D: 34, diameter: 65 mm) was connected to a distal end of a twin-screw extruder (manufactured by The Japan Steel Works, Ltd.) (screw diameter: 42 mm, L/D=48) via a connection pipe.

Next, as the compressible fluid, carbon dioxide is pressed-in from the middle of the first extruder, and the polylactic acid in which the melted inorganic particles are dispersed (filler masterbatch) and carbon dioxide as the compressible fluid are uniformly kneaded, which is cooled to a resin temperature suitable for foaming.

Subsequently, the melted resin composition is extrusion-foamed from a circular die having a slit diameter of 70 mm attached to the distal end of the second extruder under a condition of a constant discharge rate (e.g. 5 to 30 kg/h) and a constant resin temperature (e.g. 100 to 200° C.). The cylindrical polylactic acid resin foamed polylactic acid sheet extrusion-foamed from the slit of the die is placed along a cooled mandrel, and the sheet is cool-formed by blowing air to an outer face of the sheet from an air ring to obtain a foam.

In the foaming process, the compressible fluid dissolved in the polylactic acid composition vaporizes and precipitates on an interface between the inorganic particles and the polylactic acid resin in response to an operation in which the solubility of the compressible fluid is changed, such as pressure reduction and warming, so that foaming occurs. The foaming occurs from the inorganic particles as the foam core material, and therefore, only when the inorganic particles are uniformly dispersed in the polylactic acid, a foam having uniform and fine bubbles can be produced.

### <Other Processes>

Other processes are not particularly limited as long as the processes can be performed for producing a conventional foamed polylactic acid sheet. The process can be selected as appropriate depending on an intended purpose, and examples of other processes may include a forming process in which the resin is processed into a sheet shape.

### EXAMPLES

Hereinafter, Examples of the present invention will be explained. However, the present invention is not limited to Examples in any way.

### Example 1

### <Preparation of Foamed Polylactic Acid Sheet>

To a continuous foamed polylactic acid sheet forming apparatus 110 illustrated in FIG. 4, 1 part by mass of crosslinking agent (METABLEN P-1901, manufactured by Mitsubishi Chemical Corporation), 1% by mass of filler (inorganic particles) (RX 200, manufactured by NIPPON AEROSIL CO., LTD.), and a polylactic acid resin (Revode 110, manufactured by Zhejiang Hisun Biomaterials Co., Ltd) were supplied at a total flow rate of 20 kg/hr, to which 7% of carbon dioxide was added as a compressible fluid, the mixture was kneaded and then supplied to extrusion forming sections d and 4.

In a die with an outer diameter of 70 mm attached to the distal end of the extrusion forming section d, the compressible fluid was removed from an aliphatic polyester resin composition kneaded in the extrusion forming section d with a discharge rate of 20 kg/h and a polylactic acid resin temperature of 145° C. to extrusion-foam the resin composition to obtain a polylactic acid resin sheet. As results of measuring the obtained polylactic acid resin sheet, a high performance liquid chromatography (manufactured by Shimadzu Corporation) indicated that a total amount of oligomers and monomers having molecular weights of 3,000 or less was 500 ppm, and a differential scanning calorimeter (DSC) indicated that a difference between endothermic and exothermic amounts at a heating rate of 5° C./min was 7.8 mJ/mg.

### Example 2

A foamed polylactic acid sheet was obtained in the same manner as in Example 1 except that the amount of the crosslinking agent in Example 1 was changed to 0.15% by mass. As results of measuring the obtained polylactic acid resin sheet, a high performance liquid chromatography (manufactured by Shimadzu Corporation) indicated that a total amount of oligomers and monomers having molecular weights of 3,000 or less was 920 ppm, and a DSC indicated that a difference between endothermic and exothermic amounts at a heating rate of 5° C./min was 5.6 mJ/mg.

### Example 3

A foamed polylactic acid sheet was obtained in the same manner as in Example 1 except that the amount of the crosslinking agent in Example 1 was changed to 0.3% by mass. As results of measuring the obtained polylactic acid resin sheet, a high performance liquid chromatography (manufactured by Shimadzu Corporation) indicated that a total amount of oligomers and monomers having molecular weights of 3,000 or less was 800 ppm, and a DSC indicated that a difference between endothermic and exothermic amounts at a heating rate of 5° C./min was 6.5 mJ/mg.

### Example 4

A foamed polylactic acid sheet was obtained in the same manner as in Example 1 except that the content of the crosslinking agent in Example 1 was changed to 2.5% by mass. As results of measuring the obtained polylactic acid resin sheet, a high performance liquid chromatography (manufactured by Shimadzu Corporation) indicated that a total amount of oligomers and monomers having molecular weights of 3,000 or less was 400 ppm, and a DSC indicated that a difference between endothermic and exothermic amounts at a heating rate of 5° C./min was 7.6 mJ/mg.

### Example 5

A foamed polylactic acid sheet was obtained in the same manner as in Example 1 except that the content of the crosslinking agent in Example 1 was changed to 3.0% by mass. As results of measuring the obtained polylactic acid resin sheet, a high performance liquid chromatography (manufactured by Shimadzu Corporation) indicated that a total amount of oligomers and monomers having molecular weights of 3,000 or less was 350 ppm, and a DSC indicated that a difference between endothermic and exothermic amounts at a heating rate of 5° C./min was 8.1 mJ/mg.

### Example 6

A foamed polylactic acid sheet was obtained in the same manner as in Example 1 except that the content of the filler (inorganic particles) in Example 1 was changed to 0.5% by mass. As results of measuring the obtained polylactic acid resin sheet, a high performance liquid chromatography (manufactured by Shimadzu Corporation) indicated that a total amount of oligomers and monomers having molecular weights of 3,000 or less was 500 ppm, and a DSC indicated that a difference between endothermic and exothermic amounts at a heating rate of 5° C./min was 1.6 mJ/mg.

### Example 7

A foamed polylactic acid sheet was obtained in the same manner as in Example 1 except that the content of the filler (inorganic particles) in Example 1 was changed to 0.5% by mass. As results of measuring the obtained polylactic acid resin sheet, a high performance liquid chromatography (manufactured by Shimadzu Corporation) indicated that a total amount of oligomers and monomers having molecular weights of 3,000 or less was 550 ppm, and a DSC indicated that a difference between endothermic and exothermic amounts at a heating rate of 5° C./min was 2.4 mJ/mg.

### Example 8

A foamed polylactic acid sheet was obtained in the same manner as in Example 1 except that the content of the filler (inorganic particles) in Example 1 was changed to 2.0% by mass. As results of measuring the obtained polylactic acid resin sheet, a high performance liquid chromatography (manufactured by Shimadzu Corporation) indicated that a total amount of oligomers and monomers having molecular weights of 3,000 or less was 550 ppm, and a DSC indicated that a difference between endothermic and exothermic amounts at a heating rate of 5° C./min was 13.6 mJ/mg.

### Example 9

A foamed polylactic acid sheet was obtained in the same manner as in Example 1 except that the content of the filler (inorganic particles) in Example 1 was changed to 3.0% by mass. As results of measuring the obtained polylactic acid resin sheet, a high performance liquid chromatography (manufactured by Shimadzu Corporation) indicated that a total amount of oligomers and monomers having molecular weights of 3,000 or less was 550 ppm, and a DSC indicated that a difference between endothermic and exothermic amounts at a heating rate of 5° C./min was 14.8 mJ/mg.

### Example 10

A foamed polylactic acid sheet was obtained in the same manner as in Example 1 except that the filler (inorganic particles) in Example 1 was changed to RX300 (manufactured by NIPPON AEROSIL CO., LTD., primary particle diameter: 7 nm). As results of measuring the obtained polylactic acid resin sheet, a high performance liquid chromatography (manufactured by Shimadzu Corporation) indicated that a total amount of oligomers and monomers having molecular weights of 3,000 or less was 400 ppm, and a DSC indicated that a difference between endothermic and exothermic amounts at a heating rate of 5° C./min was 12.3 mJ/mg.

### Example 11

A foamed polylactic acid sheet was obtained in the same manner as in Example 1 except that the filler (inorganic particles) in Example 1 was changed to QSG100 (manufactured by Shin-Etsu Chemical Co., Ltd., primary particle diameter: 110 nm). As results of measuring the obtained polylactic acid resin sheet, a high performance liquid chromatography (manufactured by Shimadzu Corporation) indicated that a total amount of oligomers and monomers having molecular weights of 3,000 or less was 650 ppm, and a DSC indicated that a difference between endothermic and exothermic amounts at a heating rate of 5° C./min was 3.8 mJ/mg.

### Example 12

A foamed polylactic acid sheet was obtained in the same manner as in Example 1 except that the filler (inorganic particles) in Example 1 was changed to QSG170 (manufactured by Shin-Etsu Chemical Co., Ltd., primary particle diameter: 170 nm). As results of measuring the obtained polylactic acid resin sheet, a high performance liquid chromatography (manufactured by Shimadzu Corporation) indicated that a total amount of oligomers and monomers having molecular weights of 3,000 or less was 700 ppm, and a DSC indicated that a difference between endothermic and exothermic amounts at a heating rate of 5° C./min was 2.2 mJ/mg.

### Example 13

A foamed polylactic acid sheet was obtained in the same manner as in Example 1 except that the foamed polylactic acid sheet extrusion-foamed from the die in Example 1 was immediately put into a cold water bath at 10° C. As results of measuring the obtained polylactic acid resin sheet, a high performance liquid chromatography (manufactured by Shimadzu Corporation) indicated that a total amount of oligomers and monomers having molecular weights of 3,000 or less was 700 ppm, and a DSC indicated that a difference between endothermic and exothermic amounts at a heating rate of 5° C./min was 0.7 mJ/mg.

### Example 14

A foamed polylactic acid sheet was obtained in the same manner as in Example 1 except that the foam extrusion-foamed from the die in Example 1 was cut into an 800 mm-square sheet, this sheet was placed in a dryer at 70° C. for 2 hours, then taken out and slowly cooled. As results of measuring the obtained polylactic acid resin sheet, a high performance liquid chromatography (manufactured by Shimadzu Corporation) indicated that a total amount of oligomers and monomers having molecular weights of 3,000 or less was 400 ppm, and a DSC indicated that a difference between endothermic and exothermic amounts at a heating rate of 5° C./min was 16.3 mJ/mg.

### Example 15

A foamed polylactic acid sheet was obtained in the same manner as in Example 1 except that the crosslinking agent in Example 1 was changed to DURANATE D201 (manufactured by Asahi Kasei Corporation). As results of measuring the obtained polylactic acid resin sheet, a high performance liquid chromatography (manufactured by Shimadzu Corporation) indicated that a total amount of oligomers and monomers having molecular weights of 3,000 or less was 900 ppm, and a DSC indicated that a difference between endothermic and exothermic amounts at a heating rate of 5° C./min was 8.1 mJ/mg.

### Comparative Example 1

A foamed polylactic acid sheet was obtained in the same manner as in Example 1 except that the temperature of the polylactic acid resin in Example 1 was changed to 160° C. As results of measuring the obtained polylactic acid resin sheet, a high performance liquid chromatography (manufactured by Shimadzu Corporation) indicated that a total amount of oligomers and monomers having molecular weights of 3,000 or less was 1,350 ppm, and a DSC indicated that a difference between endothermic and exothermic amounts at a heating rate of 5° C./min was 8.4 mJ/mg.

### Comparative Example 2

A foamed polylactic acid sheet was obtained in the same manner as in Example 1 except that the temperature of the polylactic acid resin in Example 1 was changed to 180° C. As results of measuring the obtained polylactic acid resin sheet, a high performance liquid chromatography (manufactured by Shimadzu Corporation) indicated that a total amount of oligomers and monomers having molecular weights of 3,000 or less was 1,700 ppm, and a DSC indicated that a difference between endothermic and exothermic amounts at a heating rate of 5° C./min was 8.8 mJ/mg.

For the foamed polylactic acid sheet obtained in Examples 1 to 15 and Comparative Examples 1 and 2, “sheet contamination”, “surface property”, “puncture”, and “moldability” were evaluated. The evaluation results are presented in Table 1.

### <Sheet Contamination>

In Examples 1 to 15 and Comparative Examples 1 and 2, a total amount of oligomers and monomers having molecular weights of 3,000 or less was measured using a high performance liquid chromatography (trade name: LC-20A, manufactured by Shimadzu Corporation). From the measured values, the sheet contamination was evaluated in accordance with the following evaluation criteria. Specific measurement conditions are described below.

### [Measurement Conditions]

Column: Inertsil ODS-3 (5 μm, 4.6 mm×250 mm)
Eluate: 0.1% H₃PO₄ aq
Flow rate: 1.0 mL/min
Temperature: 40° C.
Detector: UV 210 nm

### [Evaluation Criteria]

Good: Total amount of the detected monomers and oligomers having molecular weights of 3,000 or less is less than 850 ppm
Fair: Total amount of the detected monomers and oligomers having molecular weights of 3,000 or less is 850 ppm or more and less than 1,000 ppm
Poor: Total amount of the detected monomers and oligomers having molecular weights of 3,000 or less is 1,000 ppm or more

### <Surface Property>

In Examples 1 to 15 and Comparative Examples 1 and 2, a surface of the obtained foamed polylactic acid sheet was visually observed and evaluated for “surface property” in accordance with the following evaluation criteria.

### [Evaluation Criteria]

Good: Sheet surface is uniform and clean
Fair: Sheet has slightly uneven and ununiform parts
Fair: Sheet has uneven and ununiform parts as a whole

### <Puncture>

In Examples 1 to 15 and Comparative Examples 1 and 2, a surface of the obtained foamed polylactic acid sheet was visually observed and evaluated for “puncture” in accordance with the following evaluation criteria.

### [Evaluation Criteria]

Good: No puncture is observed
Fair: No puncture is observed, but some areas are thin in thickness.
Poor: Any puncture is observed.

### <Evaluation of Moldability>

In Examples 1 to 15 and Comparative Examples 1 and 2, the obtained foamed polylactic acid sheet was molded into a shallow-drawn (mold height: 22 mm) food tray using a vacuum molding machine (FLB-21, manufactured by ASANO LABORATORIES CO., LTD.), a height of the molded tray was measured, and moldability was evaluated in accordance with the following evaluation criteria.

### [Evaluation Criteria]

Good: Container height is 21 mm or larger
Fair: Container height is 18 mm or larger and smaller than 21 mm
Poor: Container height is smaller than 18 mm

### <Overall Evaluation>

In Examples 1 to 15 and Comparative Examples 1 and 2, “overall evaluation” was performed based on the evaluation results of “sheet contamination”, “surface property”, “puncture”, and “moldability”.

### [Evaluation Criteria]

Very good: The evaluation results for “sheet contamination,” “surface property”, “puncture”, and “moldability” are all rated as “good”
Good: The evaluation results for “sheet contamination,” “surface property”, “puncture”, and “moldability” are all rated as “fair” or better, and any one of them is rated as “good”
Poor: Any one of the evaluation results of “sheet contamination,” “surface property”, “puncture”, and “moldability” is rated as “Poor”

TABLE 1

| | | | | | | Total | | | | | |
|---|---|---|---|---|---|---|---|---|---|---|---|
| | | | | | | amount of | | | | | |
| | | | | | | oligomers | | | | | |
| | | | | | DSC | and | | | | | |
| | | | | | Difference | monomers | | | | | |
| | | | | | between | having | | | | | |
| | | | | | endothermic | molecular | Evaluation results | | | | |
| | Crosslinking agent | | Filler | | and | weights of | Sheet | | | | |
| | | Content | | Content | exothermic | 3,000 or | contami- | Surface | | Mold- | Overall |
| | Type | (% by mass) | Type | (% by mass) | amounts | less | nation | property | Puncture | ability | evaluation |
| Ex. 1 | METABLEN | 1 | RX | 1 | 7.8 | 500 | Good | Good | Good | Good | Very |
| | P-1901 | | 200 | | | | | | | | good |
| Ex. 2 | METABLEN | 0.15 | RX | 1 | 5.6 | 920 | Fair | Good | Fair | Fair | Good |
| | P-1901 | | 200 | | | | | | | | |
| Ex. 3 | METABLEN | 0.3 | RX | 1 | 6.5 | 800 | Good | Good | Good | Fair | Good |
| | P-1901 | | 200 | | | | | | | | |
| Ex. 4 | METABLEN | 2.5 | RX | 1 | 7.6 | 400 | Good | Good | Good | Good | Very |
| | P-1901 | | 200 | | | | | | | | good |
| Ex. 5 | METABLEN | 3 | RX | 1 | 8.1 | 350 | Good | Good | Fair | Good | Good |
| | P-1901 | | 200 | | | | | | | | |
| Ex. 6 | METABLEN | 1 | RX | 0.3 | 1.6 | 500 | Good | Fair | Good | Good | Good |
| | P-1901 | | 200 | | | | | | | | |
| Ex. 7 | METABLEN | 1 | RX | 0.5 | 2.4 | 550 | Good | Good | Good | Good | Very |
| | P-1901 | | 200 | | | | | | | | good |
| Ex. 8 | METABLEN | 1 | RX | 2 | 13.6 | 550 | Good | Good | Good | Good | Very |
| | P-1901 | | 200 | | | | | | | | good |
| Ex. 9 | METABLEN | 1 | RX | 2.5 | 14.8 | 600 | Good | Fair | Good | Fair | Good |
| | P-1901 | | 200 | | | | | | | | |
| Ex. 10 | METABLEN | 1 | RX | 1 | 12.3 | 400 | Good | Good | Good | Good | Very |
| | P-1901 | | 300 | | | | | | | | good |
| Ex. 11 | METABLEN | 1 | QSG | 1 | 3.8 | 650 | Good | Good | Good | Good | Very |
| | P-1901 | | 100 | | | | | | | | good |
| Ex. 12 | METABLEN | 1 | QSG | 1 | 2.2 | 700 | Good | Fair | Good | Good | Good |
| | P-1901 | | 170 | | | | | | | | |
| Ex. 13 | METABLEN | 1 | RX | 1 | 0.7 | 700 | Good | Good | Good | Fair | Good |
| | P-1901 | | 200 | | | | | | | | |
| Ex. 14 | METABLEN | 1 | RX | 1 | 16.3 | 650 | Good | Good | Fair | Fair | Good |
| | P-1901 | | 200 | | | | | | | | |
| Ex. 15 | DURANATE | 1 | RX | 1 | 8.1 | 900 | Fair | Good | Fair | Fair | Good |
| | D201 | | 200 | | | | | | | | |
| Comp. | METABLEN | 1 | RX | 1 | 8.4 | 1350 | Poor | Poor | Good | Poor | Poor |
| Ex. 1 | P-1901 | | 200 | | | | | | | | |
| Comp. | METABLEN | 1 | RX | 1 | 8.8 | 1700 | Poor | Poor | Good | Poor | Poor |
| Ex. 2 | P-1901 | | 200 | | | | | | | | |

Aspects of the present invention are as follows, for example.

<1> A foamed polylactic acid sheet including:
a polylactic acid resin; and
oligomers and monomers having molecular weights of 3,000 or less in a total amount of 1,000 ppm or less.
   <2> The foamed polylactic acid sheet according to <1>, further including a crosslinking agent.
   <3> The foamed polylactic acid sheet according to <2>, wherein a proportion of the crosslinking agent is 0.5% by mass or more and 2.5% by mass or less based on the foamed polylactic acid sheet.
   <4> The foamed polylactic acid sheet according to any one of <1> to <3>, wherein a difference between endothermic and exothermic amounts at a heating rate of 5° C./min is 1 J/g or more and 15 J/g or less as determined by a heat-flux differential scanning calorimetry.
   <5> The foamed polylactic acid sheet according to any one of <1> to <4>, further including inorganic particles in an amount of 0.3% by mass or more and 5.0% by mass or less based on the foamed polylactic acid sheet.
   <6> The foamed polylactic acid sheet according to <5>, wherein a number average particle diameter of the inorganic particles is 7 nm or larger and 120 nm or smaller.
   <7> The foamed polylactic acid sheet according to <5> or <6>, wherein the inorganic particles comprise silica.
   <8> A method for producing a foamed polylactic acid sheet comprising a polylactic acid resin, the method including:
supplying the polylactic acid resin to an extruder;
kneading the polylactic acid resin at a temperature of the polylactic acid resin being 150° C. or lower to obtain a polylactic acid resin composition; and
extruding the polylactic acid resin composition from the extruder to foam the polylactic acid resin composition.

The foamed polylactic acid sheet according to any one of <1> to <7> and the method for producing the foamed polylactic acid sheet according to <8> make it possible to solve various problems in related art and achieve the object of the present invention.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2021-151348, filed on Sep. 16, 2021, in the Japan Patent Office, the entire disclosure of which is hereby incorporated by reference herein.

### REFERENCE SIGNS LIST

1 Resin pellet supplying tank
2 Filler supplying tank
3 Compressible fluid supplying tank
4 T-die
100 Continuous kneading apparatus
110 Continuous foamed polylactic acid sheet forming apparatus

1. A foamed polylactic acid sheet, comprising:
a polylactic acid resin; and
oligomers and monomers having molecular weights of 3,000 or less in a total amount of 1,000 ppm or less.

2. The foamed polylactic acid sheet according to claim 1, further comprising a crosslinking agent.

3. The foamed polylactic acid sheet according to claim 2, wherein a proportion of the crosslinking agent is 0.5% by mass or more and 2.5% by mass or less based on the foamed polylactic acid sheet.

4. The foamed polylactic acid sheet according to claim 1, wherein a difference between an endothermic amount and an exothermic amount at a heating rate of 5° C./min is 1 J/g or more and 15 J/g or less as determined by a heat-flux differential scanning calorimetry.

5. The foamed polylactic acid sheet according to claim 1, further comprising inorganic particles in an amount of 0.3% by mass or more and 5.0% by mass or less based on the foamed polylactic acid sheet.

6. The foamed polylactic acid sheet according to claim 5, wherein a number average particle diameter of the inorganic particles is 7 nm or larger and 120 nm or smaller.

7. The foamed polylactic acid sheet according to claim 5, wherein the inorganic particles comprise silica.

8. A method for producing a foamed polylactic acid sheet comprising a polylactic acid resin, the method comprising:
supplying the polylactic acid resin to an extruder;
kneading the polylactic acid resin at a temperature of 150° C. or lower to obtain a polylactic acid resin composition; and
extruding the polylactic acid resin composition from the extruder to foam the polylactic acid resin composition.
